(19) United States
(12) Patent Application Publication
(10) Pub. No.: US 2018/0232105 A1
(43) Pub. Date: Aug. 16, 2018

(54) A HOUSEHOLD APPLIANCE CONTROLLED BY USING A VIRTUAL INTERFACE

(71) Applicant: ARCELIK ANONIM SIRKETI, Istanbul (TR)

(72) Inventors: Oner HATIPOGLU, Istanbul (TR); Yusuf KUYUMCU, Istanbul (TR); Yagiz TEZEL, Istanbul (TR); Mehmet SUTCUOGLU, Istanbul (TR); Ahmet SOZEN, Istanbul (TR); Ozgur Mutlu OZ, Istanbul (TR); Can Onur VANCI, Istanbul (TR)

(21) Appl. No.: 15/751,702

(22) PCT Filed: Aug. 3, 2016
(86) PCT No.: PCT/TR2016/050260

§ 371 Date: Feb. 9, 2018

(30) Foreign Application Priority Data
Aug. 10, 2015 (TR) 2015/09836

(51) Int. Cl. G06F 3/042; G06F 3/01; F24C 15/20; G05B 15/02

(52) U.S. Cl. CPC G06F 3/0421; G06F 3/0426; G05B 2219/2613; F24C 15/2021; G05B 15/02; G06F 3/017

(57) ABSTRACT

The present invention relates to a household appliance comprising a projector which projects image of a virtual interface which enables control of household appliances within a projection area on a surface, a movement sensor which enables the gestures on the projection area to be detected, and a control unit which controls the projector and the household appliances to which the same is connected, by means of the data received from the movement sensor.

The present invention relates to a household appliance having a control unit that enables the user to control any household appliances on the surface by projecting a virtual interface on the surface by means of a projector.

With the concept of Internet of Things, household appliances used at homes, particularly in kitchens, can be controlled from a single point of control. Systems enabling the control of household appliances by projecting a virtual interface on a surface, such as a kitchen counter, by means of a projector and sensing of hand/arm gestures of the user on the virtual interface are known in the state of the art. With the projection of the virtual interface on a surface frequently used by the user in the kitchen, movements of the user sometimes cause sensing of unwanted commands by the system. In addition, apart from the respective user, any unauthorized users or pets may enter commands through the virtual interface. This situation may lead to unwanted consequences in the use of household appliances.

In the state of the art International Patent Application No. WO2010135478, control of household appliances by means of a virtual interface projected on a surface is disclosed.

In the state of the art International Patent Application No. WO2015078642, a control device integrated into an exhaust hood, by means of which the virtual interface enabling the remote control of household appliances is activated by sound is disclosed.

In the state of the art German Patent Application No. DE102009026447, projection of the input for controlling of household appliances by means of a projector and locking of the virtual interface from a mechanical switch is disclosed.

The aim of the present invention is to realize a household appliance enhancing the user experience and satisfaction by using a virtual interface.

The household appliance realized in order to attain the aim of the present invention explicated in the first claim and the respective claims thereof comprises a control unit which turns on or off the virtual interface for the use of the user by way of a predefined hand/arm gesture on the projection area of the virtual interface which enables the control of the household appliance.

In the household appliance of the present invention, the household appliance can be used in a controlled way by the control unit locking or unlocking of the virtual interface with the user-defined gestures. For example, unauthorized intervention by children by playing with the virtual interface or entering of a command by pets by walking on the virtual interface is prevented. Upon finishing the operation, the user can activate the key lock with a single hand/arm gesture without pressing any key or can turn on the virtual interface in the same way.

In an embodiment of the present invention, the control unit activates the user profile which the user has customized according to his/her habit of use with respect to the sensing of the predefined gesture by the movement sensor that turns on the virtual interface for use.

In another embodiment of the present invention, the control unit deactivates the profile of the user who uses the household appliance by sensing the predefined gesture by the movement sensor that turns off the virtual interface for use.

In another embodiment of the present invention, the control unit turns on or off the virtual interface for use by the user by means of a hand/arm gesture made on a predefined sector of the projection area. Thus, when the user makes the respective hand/arm gesture only on a part of the projection area, the virtual interface is locked or unlocked.

In another embodiment of the present invention, the control unit locks the virtual interface when the user moves the virtual interface to a predefined sector of the projection area of the projector.

In another embodiment of the present invention, the control unit locks the virtual interface when the user moves the virtual interface toward outside the projection area of the projector.

In another embodiment of the present invention, the control unit communicates in a wireless manner with the household appliances that are enabled to be controlled by the user via the virtual interface. The control unit receives and sends data such as commands of the user and responds of the household appliances to these commands by means of the techniques used in the wireless communication.

In an embodiment of the present invention, the household appliance is an exhaust hood. In this embodiment, the control unit, the projector and the movement sensor are embedded into the body of the exhaust hood. The projector on the exhaust hood projects on the kitchen counter. Thus, saving from space is enabled and also an esthetically nice appearance is achieved.

In another embodiment of the present invention, a cooker is provided, within the projection area of the projector, which is in wireless communication with the household appliance and which can be controlled from the virtual interface.

By means of the household appliance of the present invention, the users can control the household appliance and hence the household appliances in a controlled way and swiftly. Moreover, ability of the user to use the virtual interface by making the gesture of his/her choice on the selected sector of the projection area, which turns on and off the virtual interface for use, in other words, which allows the user to manage the virtual key lock application as he/she desires, provides control flexibility to the user. With this flexibility provided to the user, the user experience and satisfaction is enhanced.

The household appliance realized in order to attain the aim of the present invention is illustrated in the attached figures, where:

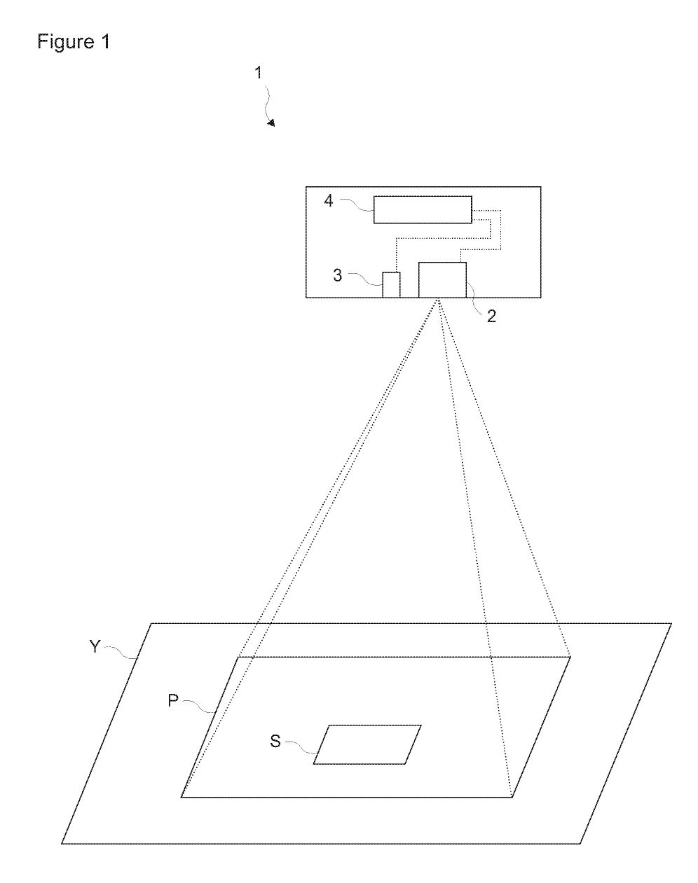

FIG. 1—is the schematic view of a household appliance.

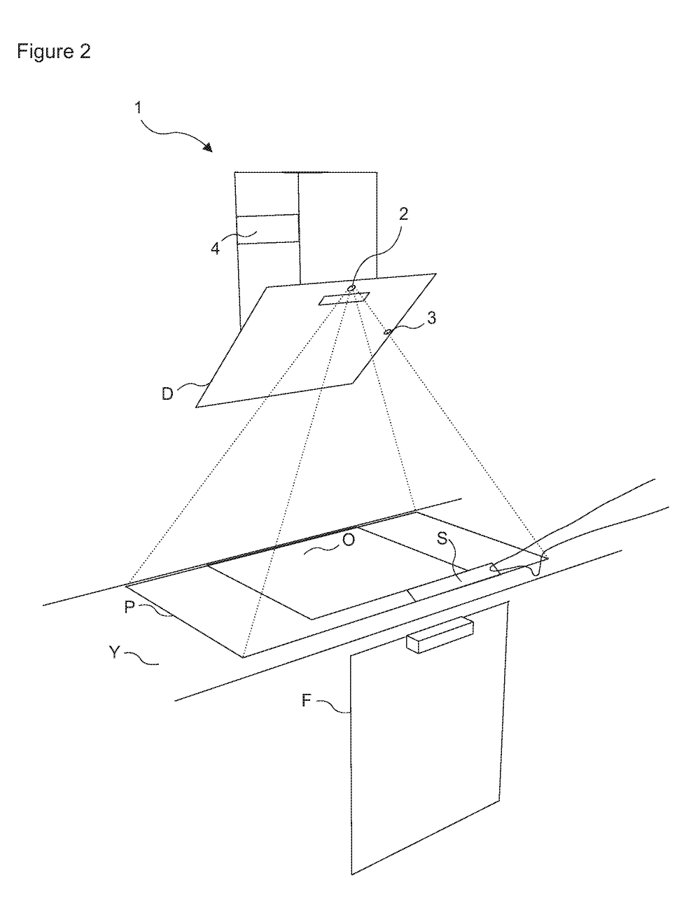

FIG. 2—is the schematic view of the household appliance related to an embodiment of the present invention.

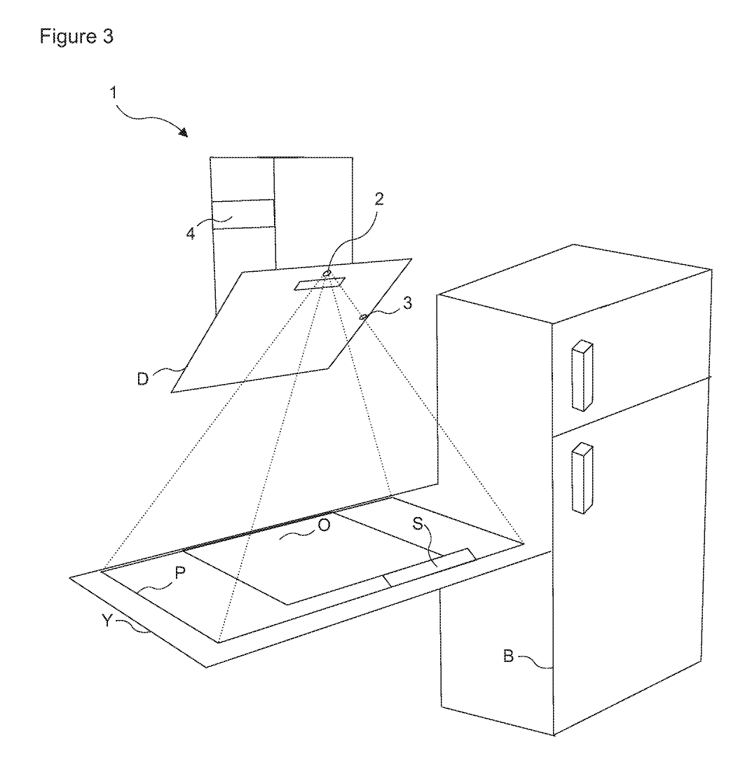

FIG. 3—is the schematic view of the household appliance related to another embodiment of the present invention.

The elements illustrated in the figures are numbered as follows:
1. Household appliance
2. Projector
3. Movement sensor
4. Control unit

The following symbols are used for explicating the household appliance (1) of the present invention.
Y: Surface
P: Projection area
S: Virtual interface
O: Cooker
D: Exhaust hood
F: Oven
B: Refrigerator

The household appliance (1) comprises a projector (2) which projects image of a virtual interface (S) which enables control of household appliances within a projection area (P) on a surface (Y), a movement sensor (3) which enables the gestures on the projection area (P) to be detected, and a control unit (4) which controls the projector (2) and the household appliances to which the same is connected, by means of the data received from the movement sensor (3).

The household appliance (1) projects by means of the projector (2) an image of the virtual interface (S) on the surface (Y) to enable the control of the household appliance (1) and other household appliances. The area on which the projector (2) casts the projection is the projection area (P), and the virtual interface (S) remains within the projection area (P), and besides the image of the virtual interface (S), also other images are projected on the projection area (P) to provide information to the user. When the user reaches by hand any key of his/her choice on the virtual interface (S), the movement sensor (3) detects the hand of the user and transmits the data to the control unit (4). The control unit (4) matches the data received from the movement sensor (3) with the image projected on the surface (Y), thus detecting which function the user wants to execute. If the user wants to execute a function related with the household appliances, the control unit (4) enables the transmission of the relevant command to the control unit (not illustrated in the figures) of the respective household appliance. Similarly, when the user wants to change the menu image of the virtual interface (S) to a different image and to change the position of the virtual interface (S), the control unit (4) controls the projector (2) and enables the projection of the desired image.

The area on which the image is projected from the projector (2) on at least a part of the surface (Y) forms the projection area (P). The projector (2) projects a still image on the projection area (P) and the virtual interface (S) that enables the control of the household appliances covers a part of the projection area (P). The user can move the virtual interface (S) to any sector of their choice so as to remain within the projection area (P).

The movement sensor (3) detects the gestures that are performed on the projection area (P). Hence, the detection area of the movement sensor (3) is the same with the projection area (P) on which the projector (2) projects the image. The movement sensor (3) can execute the detection process by using the elevation difference, as well as by using the other methods known in the state of the art. The movement sensor (3) detects the movements within the projection area (P) and transmits them, together with the position data, to the control unit (4).

The control unit (4) matches the position data with the image projected by the projector (2) and detects the action that the user wants to execute. The control unit (4) also enables the control of the household appliance (1) and any other household appliances whereto the control unit (4) is connected. The user selects by using the virtual interface (S) the household appliance (1) he/she wants to use and then executes whatever functions he/she wants by means of the virtual interface (S) of the household appliance (1).

The household appliance (1) of the present invention comprises the control unit (4) that turns on or off the virtual interface (S) for use by the user by means of a predefined hand/arm gesture on the projection area (P). By means of a single hand/arm gesture, the user can lock and unlock the virtual interface (S). By means of the present invention, the user can choose personally the gesture that locks or unlocks the virtual interface (S) for use.

The hand/arm gesture to be used for locking or unlocking the virtual interface (S) is defined as per the user preference. The hand/arm gesture can be, for example, movement of a hand up and down, making of a sign by hand, drawing of a figure by hand, and even making of a gesture by using both hands. The user is free to choose any hand/arm gesture that the movement sensor (3) can distinguish.

In an embodiment of the present invention, the control unit (4) activates the user profile of the user upon the pre-defined hand/arm gesture that turns on the virtual interface (S) for use. By means of this embodiment, when the user wants to control the household appliance (1) and any other household appliances, the user, by means of a single hand/arm gesture, both executes the aforesaid embodiment that can be characterized as unlocking of the key lock of the virtual interface (S) and activates the user profile created by the user according to his/her personal usage preferences.

In another embodiment of the present invention, the control unit (4) deactivates the user profile of the user that turns off the virtual interface (S) for use by means of the predefined hand/arm gesture. By means of this embodiment, the personal data of the user are preserved.

In another embodiment of the present invention, the control unit (4) turns on or turns off the virtual interface (S) for use through performance of a hand/arm gesture on a predefined sector of the projection area (P). By means of this embodiment, the user can turn on and off the virtual interface (S) by means of a hand/arm gesture performed only on a part of the projection area (P). Since the control unit (4) can distinguish the sector of the projection area (P) on which the hand/arm gesture is performed, the user can enter different commands by means of the same hand/arm gesture. This embodiment at the same time prevents unwanted locking of the virtual interface (S) when the user inadvertently performed the respective hand/arm gesture within the projection area (P). When the user performs the respective hand/arm gesture only on the defined sector, the virtual interface (S) is lock or unlocked.

In another embodiment of the present invention, the control unit (4) turns off the virtual interface (S) by the virtual interface (S) being moved by the user to a predefined sector of the projection area (P). For example, by moving the virtual interface (S) to the right upper corner of the projection area (P), the control unit (4) turns off the virtual interface (S) for use. The user personally chooses the sector of the projection area (P) to which the virtual interface (S) should be moved to turn it off for use.

In another embodiment of the present invention, the control unit (4) turns off the virtual interface (S) by the virtual interface (S) being moved by the user toward the outside of the projection area (P). In this embodiment, upon completion of the process, when the user slides the virtual interface (S) toward outside the projection area (P) in the same way as he/she is familiar with smartphones and tablets, the virtual interface (S) is turned off by the control unit (4). In this embodiment, when the virtual interface (S) is off for use, in other words, slid outside the projection area (P), the virtual interface (S) is not displayed on the projection area (P) or displayed as minimized on the edge of the projection area (P).

In another embodiment of the present invention, the control unit (4) turns off the virtual interface (S) for use when the virtual interface (S) is not used for a predefined period of time. In this embodiment, the user, by using the virtual interface (S), chooses the period of time at the end of which the virtual interface (S) that has remained idle until that time will be turned off for use.

In another embodiment of the present invention, the control unit (4) communicates in a wireless manner with the household appliances that the user uses by means of the virtual interface (S). In this embodiment, the control unit (4) exchanges data with the other household appliances by means of an antenna (not shown in the figures) by using Bluetooth or Wi-Fi radio frequencies. The wireless communication methods are not limited to the methods given above as example and there can be different wireless communication methods depending on the usage needs.

In another embodiment of the present invention, the household appliance (1) is an exhaust hood (D) into which the projector (2), the movement sensor (3) and the control unit (4) are integrated. Since the exhaust hood (D) is positioned by its function above the kitchen counter, the projector (2) projects its beam on a convenient surface (Y) on the counter or on a surface (Y) chosen by the user. In this embodiment, besides the exhaust hood (D), cooking appliances such as cooker (O), oven (F), etc. and cooling appliances such as refrigerator (B), etc. can be controlled.

In another embodiment of the present invention, a cooker (O) is disposed on the surface (Y) so as to remain within the projection area (P). The control unit (4) is in wireless communication with the cooker (O) and enables the cooker (O) to be controlled by means of the virtual interface (S).

In another embodiment of the present invention, the household appliance (1) is used for controlling an oven (F). The control unit (4) communicates in a wireless manner with the oven (F). The control unit (4) projects by means of the projector (2) a virtual interface (S) related to the functions of the oven (F) on the projection area (P) so as to control the oven (F) and enables the user to control the oven (F).

In another embodiment of the present invention, the household appliance (1) is used for controlling a refrigerator (B). The control unit (4) communicates in a wireless manner with the refrigerator (B). The control unit (4) projects by means of the projector (2) a virtual interface (S) related to the functions of the refrigerator (B) on the projection area (P) so as to control the refrigerator (B) and enables the user to control the refrigerator (B).

The household appliances that can be controlled by means of the household appliance (1) of the present invention are not limited to the household appliances mentioned above and the household appliance (1) can also control household appliances such as washing machine, dish washer, dryer, etc. In addition, small household appliances such as coffee maker, fruit press, food processor, etc. can be controlled by means of the household appliance (1).

By means of the household appliance (1) of the present invention, the user can easily locks the virtual interface (S) with a hand gesture and when he/she wants to use the virtual interface (S) again, he/she can do so with a hand gesture in the same way. At the same time, the user can activate his/her personal user profile with the hand gesture that turned on the virtual interface (S) for use. By means of the movement sensor (3), need for any mechanical key on the household appliance (1) to execute such processes is eliminated.

1. A household appliance comprising a projector which projects image of a virtual interface which enables control of household appliances within a projection area on a surface, a movement sensor which enables the gestures on the projection area to be detected, and a control unit which controls the projector and the household appliances to which the same is connected, by means of the data received from the movement sensor, characterized by the control unit that turns on or off the virtual interface for the use of the user by means of the performance of a predefined hand/arm gesture on the projection area.

2. A household appliance as in claim 1, characterized by the control unit that activates the user profile of the user by means of the performance of the predefined hand/arm gesture that turns on the virtual interface for use.

3. A household appliance as in claim 1, characterized by the control unit that deactivates the user profile of the user by means of the performance of the predefined hand/arm gesture that turns off the virtual interface for use.

4. A household appliance as in any the claim 1, characterized by the control unit that turns on or off the virtual interface for the use of the user by means of the hand/arm gesture performed on a predefined sector of the projection area.

5. A household appliance as in claim 1, characterized by the control unit that turns off the virtual interface by the virtual interface being slid to a predefined sector of the projection area.

6. A household appliance as in claim 1, characterized by the control unit that turns off the virtual interface for use by the virtual interface to be slid outside the projection area.

7. A household appliance as in claim 1, characterized by the control unit that communicates in a wireless manner with the household appliances controlled by the user by means of the virtual interface.

8. A household appliance which is an exhaust hood into which the projector, the movement sensor and the control unit as in claim 1.

9. A cooker which is located on the surface, which remains within the projection area and which communicates in a wireless manner with the household appliance as in claim 1 and which can be controlled by means of the virtual interface projected on the surface.
